(19) United States
(12) Patent Application Publication
(10) Pub. No.: US 2025/0155227 A1
(43) Pub. Date: May 15, 2025

(54) INTEGRATED TRACKING LASER DEFENSE SYSTEM AND METHOD

(71) Applicant: PLX, Inc., Deer Park, NY (US)

(72) Inventors: Itai Vishnia, Setauket, NY (US); Malcolm Humphrey, West Sussex (GB)

(21) Appl. No.: 17/316,196

(22) Filed: May 10, 2021

Related U.S. Application Data
(60) Provisional application No. 63/131,266, filed on Dec. 28, 2020.

(51) Int. Cl. F41H 13/00; F41H 11/02; G01S 17/66

(52) U.S. Cl. CPC F41H 13/0062; F41H 11/02; G01S 17/66

(57) ABSTRACT

An integrated tracking laser defense system for detecting and disrupting moving objects. The system includes a disruptor module arranged to steer and direct a laser on to a moving object and a plurality of tracking laser rangefinder modules, each arranged to detect and track an object as it moves in a field-of-view. The plurality of tracking laser rangefinder modules can be arranged around the disruptor module, and the disruptor module can have a fast-steering mirror device arranged to lock on to and maintain a position on the moving object as it moves in the field-of-view.

### CROSS-REFERENCE TO RELATED APPLICATION

This application claims priority to and the benefit of provisional U.S. Patent Application No. 63/131,266, titled “Integrated Tracking Laser Defense System,” filed Dec. 28, 2020, which is incorporated herein by reference in its entirety.

### FIELD OF THE DISCLOSURE

The present disclosure relates generally to optics, electronics, electronic firmware, laser technology and computing resources for detecting, tracking, or disrupting high-speed moving objects, and specifically to a device, method, and system capable of detecting, tracking and disrupting fast moving objects in multidimensional space.

### BACKGROUND OF THE DISCLOSURE

Anti-missile systems are commonly installed on aircraft, ships, land vehicles or on the ground to defend against guided missiles. The missiles are frequently infrared homing (“heat-seeking”) missiles that target the hottest part of a vehicle. Man-portable air-defense systems (MPADS), which are portable surface-to-air missiles, can be an especial threat to low-flying aircraft, with helicopters being particularly at risk. By some estimates, heat-seeking missiles, including MPADS, were believed to have been responsible for about 80% of air losses in Operation Desert Storm.

For this reason, a commonly employed counter measure against heat-seeking missiles is to deploy flares. Once deployed, the flares create large numbers of false hotspots that draw heat-seeking missiles away from the aircraft. While effective in many environments or applications, flare-deploying countermeasures can be ineffective in many other environments or applications. For instance, when an aircraft is flying slow or near the ground, the deployment of flares is not likely to be effective due to the short distance between missile launch source and aircraft.

Infrared countermeasures (IRCM) and directional infrared counter measures (DIRCM) are frequently installed on aircraft to protect against heat-seeking missiles in such, and other, environments or applications. While very effective, existing IRCM and DIRCM systems have been found by the inventors to be lacking for a variety of applications.

### SUMMARY OF THE DISCLOSURE

The disclosure provides a device, method, and system capable of detecting, tracking and disrupting moving objects such as homing missiles in multidimensional space. In a non-limiting embodiment of the disclosure, an integrated tracking laser defense system is provided for detecting and disrupting moving objects. The system can comprise a disruptor module arranged to steer and direct a laser on to a moving object and a plurality of tracking laser rangefinder modules, each arranged to detect and track an object as it moves in a field-of-view. The plurality of tracking laser rangefinder modules can be arranged around the disruptor module. The disruptor module can comprise a fast-steering mirror device arranged to lock on to and maintain a position on the moving object as it moves in the field-of-view. The disruptor module can comprise a pulsed laser source arranged to emit an infrared laser pulse that is deflected and steered by the fast-steering mirror device. The disruptor module can comprise a detector photoreceptor arranged to receive a reflection of the laser and output a laser detection signal.

In an embodiment, the integrated tracking laser defense system can comprise a processor arranged to receive the laser detection signal and determine at least one of an angle and a range of the moving object based on the laser detection signal and a position of the fast-steering mirror device. The processor can be arranged to output the angle and range continuously and in real-time to a host system controller.

In the system, the plurality of tracking laser rangefinder modules can include a laser source and a fast-steering mirror device. The laser source can be arranged to emit a laser pulse having a wavelength of about 850 nm, about 905 nm or about 946 nm.

In the system, at least one of the plurality of tracking laser rangefinder modules can include a detector photoreceptor arranged to receive a reflection of a laser pulse emitted by the laser source and output a laser pulse detection signal.

In the system, at least one of the plurality of tracking laser rangefinder modules can include a module processor arranged to receive the laser pulse detection signal and, based on a position of the fast-steering mirror device at a time when the reflection of the laser pulse is detected, find and track the fast moving object in real-time.

In the system, the processor can include digital signal processing arranged to filter optical or electronic noise to reject a false positive signal or to improve sensitivity of the at least one of the plurality of tracking laser rangefinder modules.

In the system, the processor can include digital signal processing arranged to filter optical or electronic noise to improve sensitivity of the at least one of the plurality of tracking laser rangefinder modules.

In a non-limiting embodiment, a computer-implemented method is provided for, when executed by one or more processors, detecting and disrupting a moving object by an integrated tracking laser defense system having a disruptor module and a plurality of tracking laser rangefinder modules. The method can comprise: detecting, by a detector photoreceptor, a laser pulse reflected by an object impinged by the laser; outputting, by the detector photoreceptor, a laser pulse detection signal based on the detected laser pulse; determining continuously and real-time, by a processor, a position of the object based on the laser pulse detection signal; and controlling, by a fast-steering mirror device, a disruptor laser to track the object as it moves in a field of view. The position of the object can be determined continuously and in real-time based on the position of the fast-steering mirror device while tracking the object as it moves in the field of view.

The computer-implemented method can comprise continuously determining, by the processor, angle and range information to the object and/or sending the angle and range information in real-time to a host system controller.

In the computer-implemented method, the detector photoreceptor can be located in the disruptor module or in at least one of the plurality of tracking laser range finder modules, and/or the fast-steering mirror device can be located in the disruptor module or in at least one of the plurality of tracking laser range finder modules.

The computer-implemented method can comprise: emitting, by a laser source, an outgoing laser pulse; sampling the outgoing laser pulse; determining, by the processor, a reference lock-in voltage based on the sampled outgoing laser pulse; and applying, by the processor, the reference lock-in voltage to an amplifier to generate amplitude and phase information.

The computer-implemented method can comprise sending information about the position of the object to a host system controller, wherein the position of the object comprises angle and range information, and, wherein the angle and range information is sent continuously and in real-time to the host system controller.

In a non-limiting embodiment, a non-transient computer-readable medium is provided. The computer-readable medium contains computer instructions or computer code that, when executed by one or more processors, cause an integrated tracking laser defense system to perform computer-implemented operations for detecting or disrupting a moving object, including operations comprising: detecting, by a detector photoreceptor, a laser pulse reflected by an object impinged by the laser; outputting, by the detector photoreceptor, a laser pulse detection signal based on the detected laser pulse; determining continuously and real-time, by a processor, a position of the object based on the laser pulse detection signal; and controlling, by a fast-steering mirror device, a disruptor laser to track the object as it moves in a field of view, wherein the position of the object is determined continuously and in real-time based on the position of the fast-steering mirror device while tracking the object as it moves in the field of view. The operations can comprise sending angle and range information for the object as it moves in the field of view, continuously and in real-time, to a host system controller.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a first view of a non-limiting embodiment of an integrated tracking defense system (ITDS) device, constructed according to the principles of the disclosure.

FIG. 2 shows a second view of the ITDS device in FIG. 1, where the view of the depicted embodiment is rotated 90-degrees with respect to the first view.

FIG. 3 shows a third, cross-sectional view of the ITDS device in FIG. 1, where the ITDS device in the first view is cut down the middle, along an axis.

FIG. 4 shows a non-limiting embodiment of a disruptor module, constructed according to the principles of the disclosure.

FIG. 5 shows a pair of alternative non-limiting embodiments of a detector photoreceptor that can be included in the ITDS device.

FIG. 6 shows a block diagram of a non-limiting embodiment of a controller.

FIG. 7 shows a block diagram of a non-limiting embodiment of a disruptor controller.

FIG. 8 shows a block diagram of a non-limiting embodiment of a T-LRF controller.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

A number of DIRCM systems are currently in use or in development by aerospace companies around the world. Such systems typically use laser countermeasure technologies that require a gimballed motorized optical head to direct laser beams onto incoming missiles. These systems tend to require a separate Missile Approach Warning (MAW) system to direct the optical head to the approximate bearing of the incoming missile, so that the laser can be aimed in that direction. The laser nutates until sufficient reflection from the missile is returned and the system can lock on to the missile. The laser radiation is sufficiently intense to saturate or damage the infrared (IR) sensor inside the heat-seeking missile.

MAW systems typically rely on either passive or active detection technologies. Passive MAW systems tend to use IR or ultraviolet (UV) radiation sensing technologies to detect missiles, whereas active MAW systems tend to use radar technologies. Passive systems can produce accurate angle of attack information, but not range. Active radar systems can produce accurate range, but not accurate angle of attack information. Hence, one of the drawbacks of existing DIRCM systems is that they require a separate MAW system to direct the DIRCM technology onto an incoming missile, thereby increasing complexity, cost, weight and power requirements.

For instance, the motorized, gimballed laser director required in many DIRCM systems adds significant weight and complexity, while at the same time limiting the DIRCM systems' response and acquisition times. These are significant drawbacks, since these systems must detect and disrupt incoming missiles rapidly as the time to impact from missiles launched nearby can be on the order of a few seconds. The separate systems and motorized gimballed optical mount introduce significant time delays in both acquisition and disruption.

Further, MAW systems may not be able to provide an accurate angle of attack or range, or they may have to use multiple technologies to achieve both.

The instant disclosure provides an integrated tracking defense system (ITDS) technology, which includes an ITDS device, and ITDS system and an ITDS computer-implemented methodology. The ITDS technology provides fast acquisition and disruption times compared to existing technologies such as, for example, IRCM or DIRCM. The ITDS technology can provide sub-second performance, including disruption times that are well under a second.

The ITDS technology can include a passive mode that can eliminate emissions by tracking laser rangefinders (T-LRF) that might otherwise be locked onto by missiles.

The ITDS technology can include an active mode wherein the technology is unlikely to be detected. In this regard, the technology can operate with frequencies or wavelengths that are undetectable to existing heat-seeking (or IR) missiles. For instance, the technology can include a laser source that generates a coherent, highly collimated light beam (laser) having a frequency or wavelength that is outside the spectrum detectable by IR missiles, such as, for example, a 905 nm wavelength.

The ITDS technology can be arranged to provide detection, accurate angle of attack and range information, without needing to use radar. Thus, the ITDS technology can be implemented with stealthy platforms, without increasing risk of detection.

The ITDS device and ITDS system can be significantly smaller, lighter, lower power and cost less than existing DIRCM systems or other similar technologies. The ITDS technology can include compact, lightweight and low-power components such as fast-steering mirror (FSM) devices. The FSM devices can include, for example, microelectromechanical systems (MEMS), voice coil mirrors (VCMs), piezoelectric actuator mirrors (PACs), or any gimbal-less single or dual-axis mirror device that can meet size, weight, power and performance requirements for inclusion in the ITDS device.

or any beam steering device capable of achieving steering responsiveness contemplated by this disclosure.

Unlike gimballed motorized mounts in existing DIRCM systems, the FSM device can be arranged to direct and quickly maneuver a laser by means of a small mirror, without needing to drive and maneuver a heavy, costly, and power-hungry motor and mount structure. Moreover, the FSM device can increase reliability, while reducing maintenance, energy and size requirements.

The ITDS device and ITDS system can include a fast-detection sensor (FDS) device. The FDS device can include, for example, a single FDS device or an array of FDS devices that can be arranged to sense reflections of a laser beam from a moving object such as a missile. The FDS device can be arranged to co-axially sense reflections of the laser from the object. The FDS device can be connected (directly or indirectly) to provide feedback of, for example, the direction from which a reflected laser is the strongest, thereby facilitating rapid acquisition of the target by the FSM device and reducing or eliminating any need to nutate the laser.

The ITDS device and ITDS system can be arranged to pulse the laser as one or more laser pulses or bursts, such that, for example, it can be used for range-finding to determine a distance between the ITDS device and the object. In this regard, the ITDS device or system can include a processor that can calculate the distance based on direct time-of-flight or using a digital signal processor (DSP) based lock-in amplifier to provide amplitude and phase information.

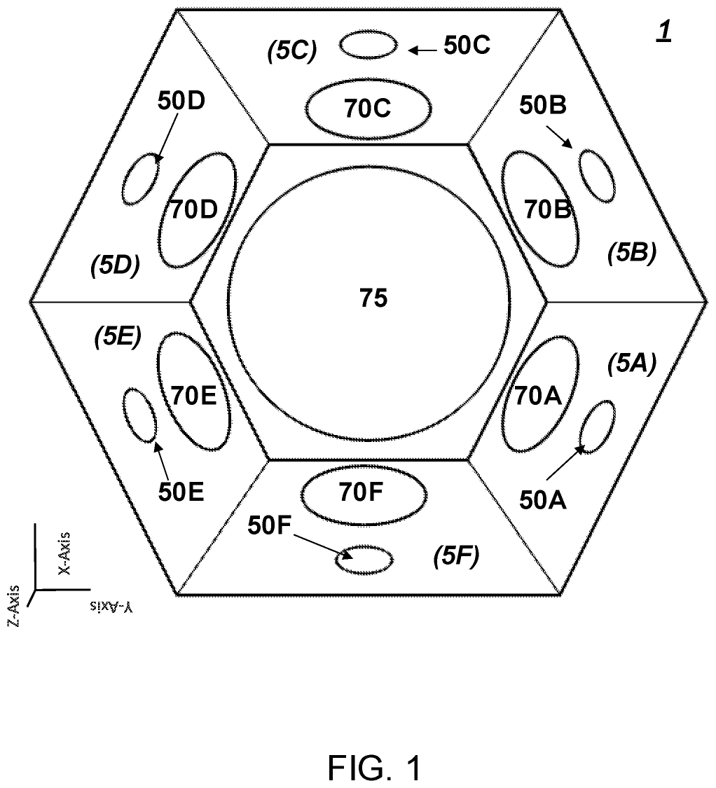

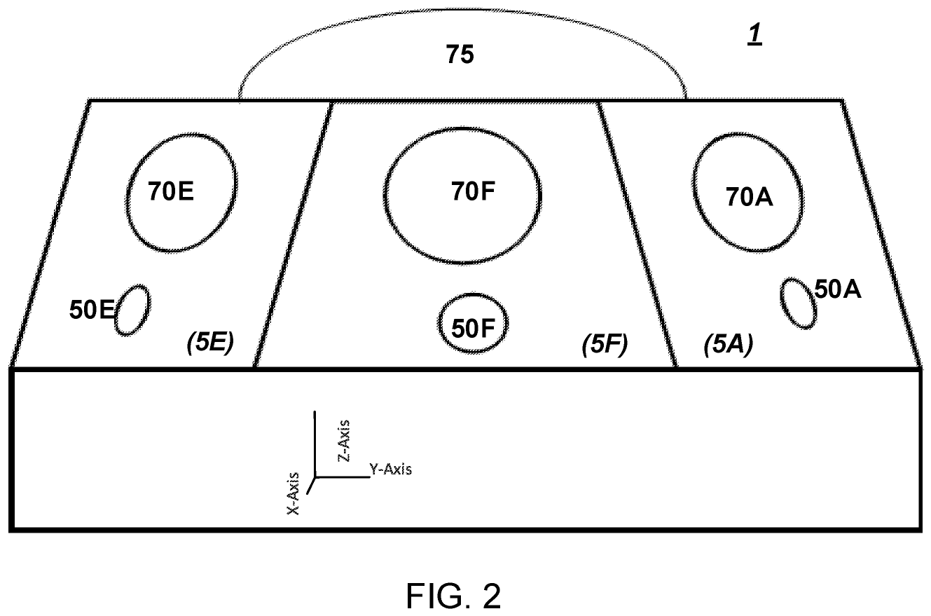

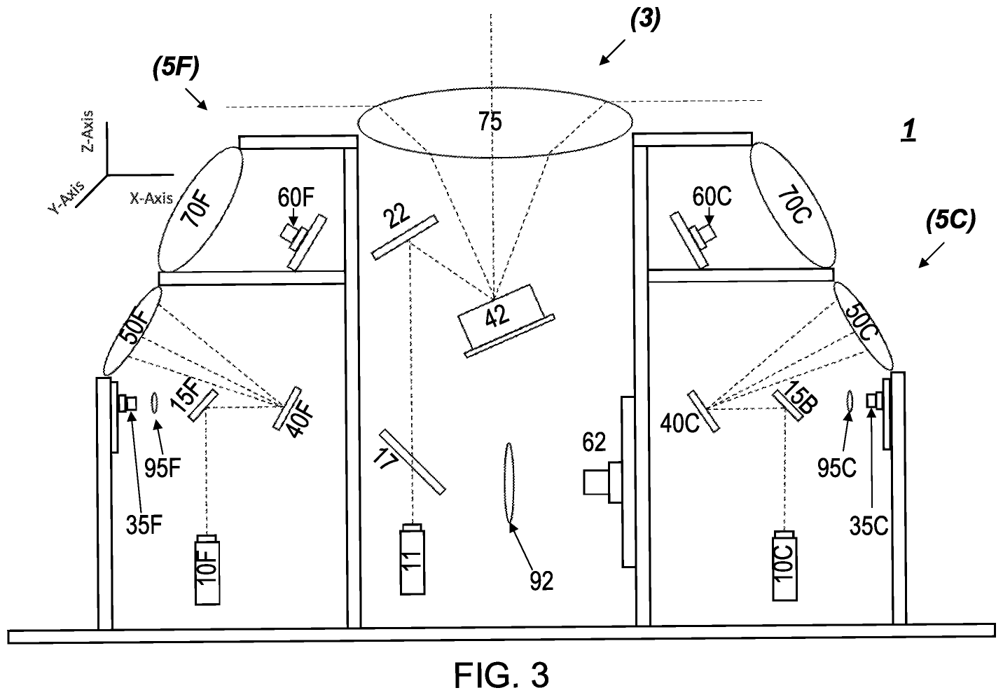

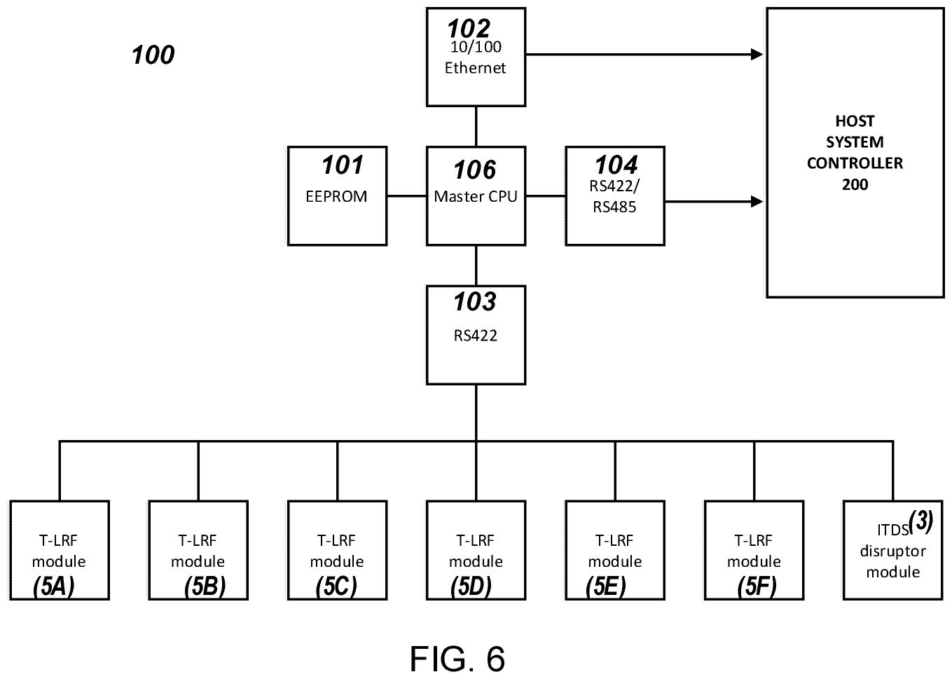

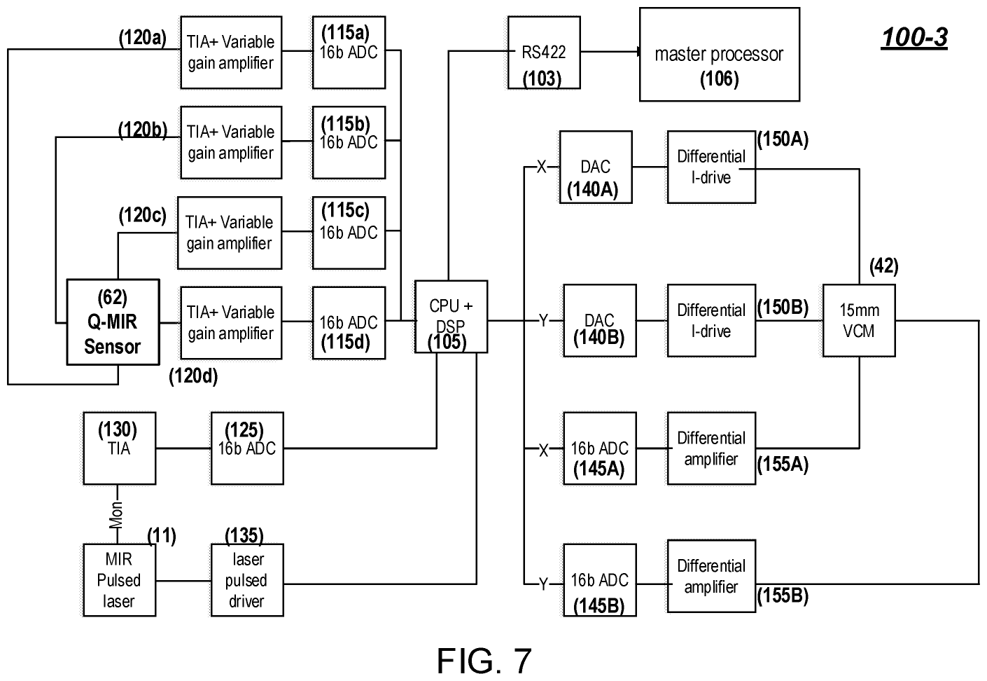

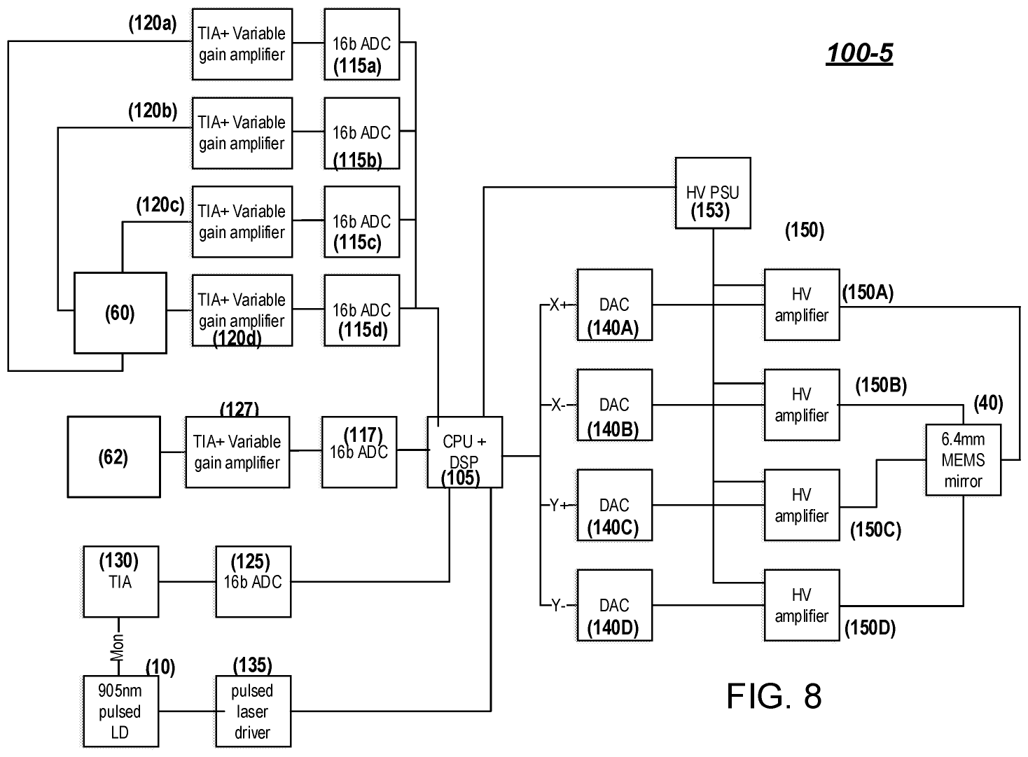

FIGS. 1-3 show three different views of a non-limiting embodiment of an ITDS device 1 constructed according to the principles of the disclosure. FIG. 1 shows a planar view of the ITDS device 1; FIG. shows a side view of the device; and FIG. 3 shows a cross-sectional view, in which the ITDS device 1 depicted in FIG. 1 is cut down the middle, along the X-axis. The ITDS device 1 can include one or more disruptor modules 3. The ITDS device can include one or more tracking laser rangefinder (T-LRF) modules 5. In the embodiment depicted in FIGS. 1-3, the ITDS device 1 has one disruptor module 3 and six T-LRF modules 5, including 5A, 5B, 5C, 5D, 5E, and 5F. The ITDS device 1 can include a ITDS device controller 100 (shown in FIG. 6), which can include a disruptor controller 100-3 and a T-LRF controller 100-5 corresponding to each T-LRF module 5. The disruptor module 3 can include, for example, the architecture depicted in FIG. 7, including a disruptor module controller 100-3. Each T-LRF module 5 can include, for example, the architecture depicted in FIG. 8, including the T-LRF controller 100-5.

Each T-LRF module 5 (including 5A, 5B, 5C, 5D, 5E, or 5F) can include a housing and can be arranged to be next to, connected to, in proximity of, or share a common housing with the disruptor module 3 as seen the embodiment depicted in FIG. 3. The ITDS device 1 can include any number of T-LRF modules 5, including, for example, three, four, five, six or more T-LRF modules 5 arranged circumferentially around the centrally located disruptor module 3, thereby providing all aspect field of views around the ITDS device 1.

In an embodiment, the ITDS device 1 can be arranged or assembled to provide 360-degree field-of-view. Each T-LRF module 5 can be provided as a module. The plurality of T-LRF modules 5 can be arranged in any configuration suitable for the application. For instance, in an embodiment, the ITDS device 1 can be arranged in a circle as discrete modules and arranged for 360-degree field-of-view coverage, as seen in the non-limiting embodiment depicted in FIG. 1.

In an embodiment, parts/components in the ITDS device 1 can be constructed to be modular, so that components can be readily replaceable or removable. For instance, the laser source 10 (or 11) can be removed and replaced with a laser source having different properties (for example, wavelength, power). Any of the components can be configured to be “plug-and-play” for ease in replaceability.

In an embodiment, the architecture of the ITDS device 1 can include a housing. The architecture can include one or more M.O.S.T. (Monolithic Optical Structure Technology) platforms, which can be arranged to bond parts/components that require critical alignment and stability with a rigid structure that is thermal-agnostic or shock/vibration-agnostic-for example, the alignment between parts/components changes minimally (or not at all) with temperature, vibration, shock or other ambient conditions, thereby providing improved accuracy with ambient variations, including temperature, humidity, pressure, or the like.

The laser sources 10 in the T-LRF modules 5 can be selected, or made adjustable to select, specific wavelengths that can disrupt IR seeker missile heads. An advantage of this embodiment is that the ITDS device 1 can be configured to disrupt multiple missiles from different angles of attack. In this embodiment, the disruptor module 3 can be omitted.

While the embodiment depicted in FIGS. 1-3 is arranged to comprise six T-LRF modules 5 surrounding the disruptor module 3, in other embodiments (not shown) any number of T-LRF modules 5 can be included or arranged according to any configuration suitable to a particular application. Increasing the number of T-LRF modules 5 can decrease target acquisition times.

Each T-LRF module 5 can be arranged to include its own dedicated T-LRF controller 100-5 (for example, shown in FIG. 8). The T-LRF controller 100-5 can include digital signal processing electronics, such as, for example, those in the embodiment depicted in FIG. 8. The T-LRF controller 100-5 can include one or more computing devices and one or more computing resources. Similarly, the disruptor module 3 can be arranged to include its own dedicated disruptor controller 100-3 (for example, shown in FIG. 7). The disruptor controller 100-3 can include signal processing electronics, including one or more computing device and one or more computing resources. A controller 100 can be arranged to interact with and control operations of each T-LRF module 5 and the disruptor module 3, as seen in the embodiment of the controller 100 depicted in FIG. 6.

FIG. 6 shows a non-limiting embodiment of the controller 100, constructed according to the principles of the disclosure. The ITDS device 1 can include the controller 100, which can be configured to handle and control operations of the ITDS device 1, including the disruptor module 3 and each T-LRF module 5. The controller 100 can include an input-out (IO) interface arranged to facilitate communications with a host system controller 200. The host system controller 200 can include, for example, one more computing devices, communications devices or computing resources arranged to control operations of a vehicle (such as, for example, aircraft, vessel, ship, or land vehicle) or a ground station. The controller 100 can include a master processor 106 arranged to communicate with each T-LRF module 5 and the disruptor module 3 via a high-speed communication links 103. The communication link(s) can include, for example, a RS422 bus, to minimize latency and for optimum electromagnetic compatibility compliance. The master processor 106 can be arranged to communicate with the host system controller through one or more communication links 102, 104. The communication links 102, 104, can include, for example, a 10/100 Ethernet interface and an RS422/RS4385 bus.

The controller 100 can be arranged to control operations in the ITDS device 1, including signal acquisition and sensing of frequency and harmonic content of outgoing laser pulses as the reference signal, and the reflected laser pulse signals received and measured by disruptor controller 100-3 and T-LRF controllers 100-5. The reference signal and received pulse signals can be processed, for example, in a DSP-based lock-in amplifier in the controller 100-3 (for example, in the processor 105) or controller 100-5 (for example, in the processor 105) to determine amplitude and phase information of the received pulses from the distant target. The amplitude information can be used by the controller 100-3 or controller 100-5, as applicable, to determine if a laser is reflecting off a target or going into free space. The phase information can be used to determine the range to the target.

The disruptor controller 100-3 (or T-LRF controller 100-5) can be arranged to operate and steer a laser to nutate the laser based on the amplitude and phase information, in order to maintain a close lock between the laser and target. For instance, the controller 100-3 (or 100-5) can control the laser source 11 (or 10) and FSM device 42 (or 40) to direct, steer and maintain a close lock of the pulsating laser on the target by synchronizing and locking the FSM device 42 (or 40) angular position to the target angle, for example, to keep the pulsating laser impinging a point or a small area on the object for a period of time. The mirror angle information and range information can be continuously fed back by the controller 100 to the host system controller 200 at a high refresh rate.

In an embodiment that includes the lock-in amplifier, the controller 100-3 or controller 100-5 can be enabled to receive a return laser signal that is, for example, 30 dB or more below the noise floor of the ambient optical and electronic noise present at the ITDS device 1. Thus, the range and performance of the ITDS device 1 can be extended significantly while maintaining the eye-safe aspect of the laser.

Each T-LRF module 5 in the embodiment depicted in FIGS. 1-3, can include a laser source 10, a beam splitter (BS) 15, a fast-steering mirror (FSM) device 40, an emission sensing photoreceptor (ESPR) device 35, an emission optical system 50, a lens system 95, a detector photoreceptor (DPR) device 60, and a light collecting (LC) optical system 70. Each T-LRF module 5 can include a passive mode and an active mode. In the passive mode, the T-LRF module can detect and track moving objects with emitting energy that might be detected by, for example, an IR seeking missile. In the active mode, the T-LRF module 5 can lock-on and track the moving object in real-time. The T-LRF module 5 can be arranged to provide both a passive and an active missile attack warning system and tracking system.

In the embodiment depicted in FIGS. 1-3, the laser source 10 includes laser sources 10A, 10B, 10C, 10D, 10E, or 10F; the beam splitter (BS) 15 includes beam splitters 15A, 15B, 15C, 15D, 15E, or 15F; the fast-steering mirror (FSM) device 40 includes FSM devices 40A, 40B, 40C, 40D, 40E, or 40F; the emission sensing photoreceptor (ESPR) device 35 includes ESPR devices 35A, 35B, 35C, 35D, 35E, or 35F; the emission optical system 50 includes emission optical systems 50A, 50B, 50C, 50D, 50E, or 50F; the lens system 95 includes lens systems 95A, 95B, 95C, 95D, or 95E); the DPR device 60 includes DPR devices 60A, 60B, 60C, 60D, 60E, or 60F; and, the LC optical system 70 includes LC optical systems 70A, 70B, 70C, 70D, 70E, or 70F.

In an embodiment of the ITDS device 1, the T-LRF device 5 can include, for example, any of the embodiments of the T-LRF device 1 described in commonly-owned co-pending U.S. patent application Ser. No. 17/225,281, filed Apr. 8, 2021, titled “TRACKING LASER RANGEFINDER SYSTEM AND METHOD,” the disclosure of which is hereby incorporated herein in its entirety.

The laser source 10 can include a laser beam or laser pulse (or burst) generator, such as, for example, a solid-state laser, a gas laser, an excimer laser, a dye laser, a semiconductor laser (for example, a laser diode), or any device that can emit a continuous beam, a pulse beam or a burst of coherent and highly collimated light. The laser source 10 can include a collimator lens (not shown), a zoom lens (not shown), a laser line generator lens (not shown), a Powell lens (not shown), a non-telecentric lens (not shown), or a focus lens (not shown). The laser source 10 can be arranged, or can be controlled, to adjust properties of the laser, including, for example, direction, wavelength, gain bandwidth, monochromaticity, spatial or temporal profiles, collimation, output power, coherence, or polarization.

In a non-limiting embodiment, the laser source 10 comprises a pulsed laser source such as, for example, a photodiode (PLD), a short-pulsed laser diode, a fiber laser, a DPSS (diode-pumped solid-state) laser, q-switched laser, or any laser suitable for the particular application, as will be understood by one skilled in the relevant art. The laser source 10 can be arranged to generate a coherent, highly-collimated light at, for example, 90 watts (W) or 100 W, and having a wavelength of 905 nanometers (nm). The laser source 10 can be arranged to generate wavelengths short than 905 nm, or longer than 905 nm, or power greater than, or less than 90 W. For instance, the laser source 10 can be arranged to generate wavelengths in the range, for example, between 635 nm and 980 nm, including, for example, about 850 nm, about 905 nm or about 946 nm. Depending on the application for the ITDS device 1, the wavelength can be generated so as to be outside the range of detection by targets of the application.

In another non-limiting embodiment, the laser source 10 can be arranged to generate a pulsed laser at 50 kW and 1534 nm, a pulsed laser at 5 kW and 1550 nm, or a pulsed laser at 100 W and 1550 nm, or any combination thereof, in which case the pulsed laser can be generated simultaneously or alternatingly. In other embodiments, the laser source 10 can include power-ratings that are greater (or less) than any of the foregoing power-ratings, or wavelengths that are greater (or less) than any of the foregoing wavelengths.

The wavelength-power combinations selected for the laser source 10 can vary, depending on application. For instance, the 905 nm-90 W wavelength-power selection can be used to achieve lower eye-safety power levels. However, higher power wavelength-power combinations can be used where eye-safety is less of concern.

In an embodiment, the laser source 10 can be arranged to output lasers having wavelengths that would disrupt IR seeker missiles. Since the ITDS device 1 includes a plurality of T-LRF modules 5, it can disrupt multiple missiles from different angles of attack simultaneously. In this non-limiting embodiment, the disruptor module 3 can be omitted.

The beam splitter (BS) 15 can include, for example, a short-pass dichroic beam splitter, a long-pass-dichroic beam splitter, or a polarizing beam splitter. The BS 15 can be constructed such that loss of power or intensity of the deflected (or reflected) laser is minimized to near-zero levels. The beam splitter 15 can be constructed such that power/intensity loss during deflection (or reflection) is negligible.

The beam splitter (BS) 15 can be arranged to allow a portion of the laser emitted from the laser source 10 to be directed to the ESPR device 35.

In an embodiment, the beam splitter 15 includes a short-pass dichroic beam splitter in the laser source path to reflect, for example, a 905 nm laser, whilst allowing shorter wavelengths to pass through to the ESPR device 35, which in this embodiment includes a QAPD.

In an alternative embodiment, the beam splitter 15 includes a long-pass dichroic beam splitter and the ESPR device 35 includes a quadrant MIR sensor to detect the stronger MIR emissions of, for example, rocket motors.

Inclusion of the ESPR device 35 and DPR device 60 enables coaxial sensing of visible to near-infrared (NIR) wavelengths of light in the field-of-view of the T-LRF module 5. Combined with the scanning of each FSM device 40, the T-LRF module 5 can operate in a passive sensing mode to detect the bright visible-NIR emissions of missile rocket engines. The T-LRF module 5 can include a long-pass beam splitter 15 with an MIR quadrant sensor for the ESPR device 35, where less sensitive to sunlight is desirable.

The FSM device 40 can include, for example, a single-axis MEMS mirror, a dual-axis MEMS mirror, a single-axis micro-opto-electro-mechanical system (MOEMS) mirror, a dual-axis MOEMS, a single axis coil mirror (CM), a dual-axis CM, a single axis voice-coil mirror (VCM), a dual-axis VCM, a piezoelectric actuator mirror (PAC), or any gimbal-less single or dual-axis mirror device that can meet size, weight, power and performance requirements for inclusion in the T-LRF module 5. The FSM device 40 can be arranged to scan the laser in a scan plane along a scan-axis. For instance, in the embodiment depicted in FIG. 3, the FSM device 40F can be arranged to scan the laser in the Y-Z plane along the Z-Axis. The FSM device 40 can be arranged to scan an entire field of view of that T-LRF module 5. The FSM device 40 can be arranged to be driven (for example, by a dual-axis driver circuit) to steer the laser to impinge any point in the multidimensional field-of-view of corresponding T-LRF module 5.

In the embodiment depicted in FIG. 3, the FSM device 40 includes a 2 mm MEMS mirror.

The FSM device 40 can include a built-in position feedback for accurate and fast-response control. The MEMS device can include, for example, electromagnetic, electrostatic or piezo-based MEMS devices. The FSM device 40 can include any suitable fast-steering mirror device. The FSM device 40 can include, for example, a tip/tilt mirror platform, a fast tip/tilt steering mirror, a tip/tilt piston mirror, a tip/tilt/piston platform, a piezo-Z stage, or a piezo-Z tip-tilt stage.

The ESPR device 35 can include, for example, a photoreceptor or photosensor, or an array of photoreceptors or photosensors. The array can include a one-dimensional array or a multidimensional array (for example, 2-dimensional or 3-dimensional array) of photoreceptors or photosensors. The photoreceptor or photosensor can include a semiconductor-based device such as, for example, a photodiode, a phototransistor, a solaristor or a charge-coupled device (CCD). The ESPR device 35 can include a photoreceptor or photosensor arranged to detect a light having properties corresponding to the laser generated by the laser source 10, such as, for example, wavelength or frequency. The ESPR device 35 can include, for example, a focal plane array, an Avalanche photodiode (APD), a silicon APD (SiAPD), a silicon photomultiplier (SiPM), a photomultiplier tube, an InGaAS (Indium/Gallium/Arsenide) Avalanche photodiode (APD), a quadrant APD (QAPD), a midinfrared (MIR) sensor, a quadrant MIR sensor.

In the embodiment depicted in FIG. 3, the ESPR device 35 includes a quadrant MIR sensor.

The emission optical system 50 can include one or more lenses, one or more beam splitters, one or more mirrors, one or more shutters, one or more filters, one or more polarizers, or other optics components. The emission optical system 50 can include, for example, a collimator lens (not shown), a zoom lens (not shown), a laser line generator lens (not shown), a Powell lens (not shown), a telecentric lens (not shown), a non-telecentric lens (not shown), a focus lens (not shown), a beam expanding lens (shown in FIG. 3), or any optical component suitable for implementation of the intended application for the IDTS device 1.

In the embodiment depicted in FIG. 3, the emission optical system 50 includes a beam expanding lens to increase the field-of-view of each T-LRF module 5.

The DPR device 60 can include, for example, a photoreceptor or photosensor, or an array of photoreceptors or photosensors. The array can include a one-dimensional array or a multidimensional array (for example, 2D or 3D array) of photoreceptors or photosensors. The photoreceptor or photosensor can include a semiconductor-based device such as, for example, a photodiode, a phototransistor, a solaristor or a CCD. The DPR device 60 can include a photoreceptor or photosensor arranged to detect a light having properties corresponding to the laser generated by the laser source 10, such as, for example, wavelength or frequency. The DPR device 60 can include, for example, a focal plane array, an APD, a SiAPD, a SiPM, a photomultiplier tube, an InGaAS APD, a QAPD, a MIR sensor or a quadrant MIR sensor.

In the embodiment depicted in FIG. 3, the DPR device 60 includes a silicon APD (SiAPD).

The LC optical system 70 can include one or more lenses, one or more beam splitters, one or more mirrors, one or more shutters, one or more filters, one or more polarizers, or other optics components. The LC optical system 70 can include, for example, a collimator lens (not shown), a zoom lens (not shown), a laser line generator lens (not shown), a Powell lens (not shown), a telecentric lens (not shown), a non-telecentric lens (not shown), a focus lens (not shown), or any optical component suitable for implementation of the intended application for the IDTS device 1.

In the embodiment depicted in FIG. 3, the LC optical system 70 includes light collecting or filter optics.

The lens system 95 can include, for example, a focus lens.

In each T-LRF module 5, the laser source 10 can be triggered to generate and emit a laser pulse or laser burst, which can be emitted from the T-LRF module through the emission optical system 50. As seen in the embodiment depicted in FIG. 3, the laser (beam, pulse or burst) from the laser source 10 can be deflected and directed by the beam splitter 15 to the FSM device 40. The FSM device 40 can be arranged to receive the light from laser source 10 (either directly or via the beam splitter 15) and deflect and steer the laser through the emission optical system 50 to the target. The outgoing laser can be sampled and used as a reference level for a lock-in amplifier, which can then generate amplitude and phase information by, for example, combing the reference level and incoming pulses.

The LC optical system 70 can be arranged to receive reflections of the outgoing lasers, after they impinge an object and are reflected back as return lasers to the T-LRF module 5. The LC optical system 70 can be arranged to collect a return laser and direct the return laser to the DPR device 60, which can then sense the light energy of the return laser and output a pulse signal corresponding to the position, intensity or timing of the return laser. The resultant pulse signal can be processed by the controller 100 to determine a location of the target in real-time with respect to the ITDS device 1.

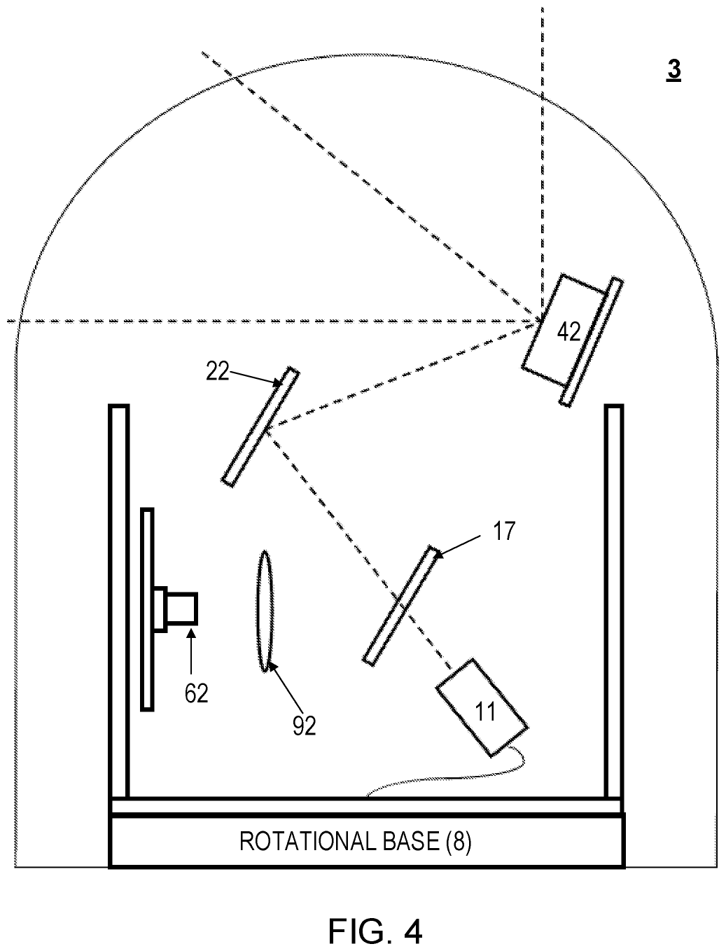

FIG. 4 shows a non-limiting embodiment of a disruptor module 3, constructed according to the principles of the disclosure. As seen in the embodiment depicted in FIG. 4, the disruptor module 3 can include a housing having a rotational base 8. The rotational base 8 can include a rotary actuator and a rotary fiber optic joint. The rotational base 8 can be constructed and arranged to pivot, as well as rotate.

Referring to the embodiments of the disruptor module 3 depicted in FIGS. 3 and 4, the disruptor module 3 can include a laser source 11, a first mirror 17, a second mirror 22, a fast-steering mirror (FSM) device 42, a detector photoreceptor (DPR) 62, and a lens 92. The disruptor module 3 can include a dome 75. The dome 75 can include one or more optical components. The dome 75 can include beam expanding optics.

The laser source 11 can be constructed similar to, the same as, or include the laser source 10. In the embodiments depicted in FIGS. 3 and 4, the laser source 11 includes a multiband (MIR) pulsed laser source arranged to generate a laser with more than 100 W of power. The laser 11 can include a fiber laser collimator (not shown).

The laser source 11 can be arranged to generate and emit a pulsed disruptor laser. Outgoing and returning disruptor laser pulses can be monitored and timed by the master controller to provide range information to, for example, a moving object that is being tracked or under impingement of the disruptor laser to destroy or damage the object, or alter its velocity or direction vectors.

The first mirror 17 can include a mirror with a center aperture. The mirror 17 can be arranged to allow the laser to pass therethrough unobstructed, as seen in FIG. 3 or 4. The mirror 17 can be arranged to deflect a return laser to the DPR 62.

The lens 92 can be positioned in the path of the return laser, between the mirror 17 and DPR 62. The lens 92 can include a focus lens positioned to focus the return laser on to the DPR 62.

The DPR 62 can be constructed similar to, the same as, or it can include the DPR 60. In the embodiment depicted in FIG. 3 or 4, the DPR 60 includes a focal plane array or a quadrant MIR detector. The DPR 62 can be arranged to be impinged by the return laser, detect an energy/intensity level and position, and output amplitude and phase information for the return laser.

The second mirror 22 can be arranged between the laser source 11 and FSM device 42. The mirror 22 can be arranged between the mirror 17 and the FSM device 42. The mirror 22 can include a fixed mirror. The mirror 22 can be arranged to deflect the outgoing laser from the laser source 11 to the FSM device 42, and deflect the return laser from the FSM 42 to the DPR 62. The mirror 17 or lens 92 can be included in the optical path of the return laser, between the mirror 22 and DPR 62.

The FSM device 42 can be constructed similar to, the same as, or include the FSM device 40. In the embodiments depicted in FIG. 3 or 4, the FSM device 42 includes a 15 mm VCM (voice-coil mirror) device. The FSM device 42 can be arranged to direct and steer a laser using microelectronic-scaled devices. Unlike existing gimballed motorized mounts that are large, heavy, slow, and require a lot of power to power, the FSM device 42 facilitates a significantly smaller footprint for the disruptor module 3, allowing for much lower power requirements while providing much higher response times.

The ITDS system 1 includes co-axial sensing by DPRs 60 or 62, where reflections (return lasers) of the laser source off the moving object are sensed and fed back in real-time to steer the FSM device 42 to ensure consistent and rapid targeting of the laser by the disruptor module 3. The DPRs 60 or 62 can provide a feedback signal that indicates the direction in which the reflection (or return laser) is the strongest, thereby enabling the FSM device 42 (or 40) to rapidly acquire the target and reduce or eliminate any need to nutate the laser.

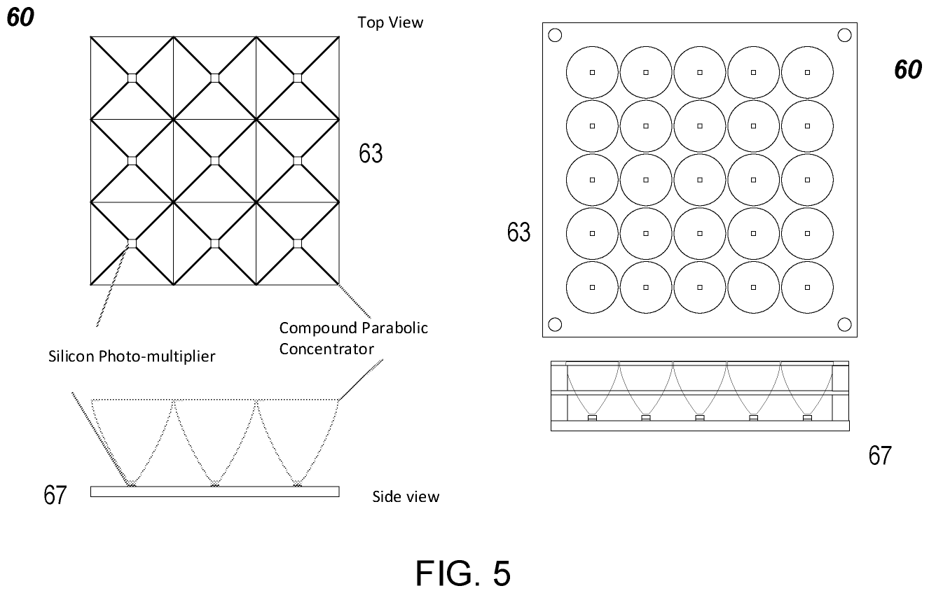

FIG. 5 shows a pair of alternative non-limiting embodiments of the DPR device 60 (or 62) containing an array of compound parabolic concentrators 63 arranged to concentrate light onto an array of photoreceptors 67, such as, for example, an array of silicon photomultipliers (SiPM). The outputs of the individual photoreceptors can be filtered and combined electronically such that noise can be minimized and the overall speed preserved. The embodiment depicted in FIG. 5 allows achievement of a large area for gathering light, whilst maintaining an acceptance angle for off-axis targets that are within the field-of-view of the laser.

The laser generated by the disruptor module 3 or the T-LRF module 5 can include a pulsed laser that can be used for range-finding, either through direct time-of-flight (ToF) or via a digital signal processing (DSP) based lock-in amplifier providing amplitude and phase information.

The ITDS device 1 can be arranged to employ a passive mode on each T-LRF module 5. In the passive mode, each T-LRF module 5 can be arranged to keep the laser source 10 turned OFF, thereby eliminating any emission that a guided moving object such as, for example, a heat-seeking missile, might lock on to. Even in active mode, the laser emitted by the laser source 10 can be configured so as to avoid detection by the moving guided moving object. For instance, in the active mode, the laser source 10 can be arranged to output a 905 nm laser, which is outside the active wavelength band of legacy or modern IR missiles.

The ITDS device 1 can be arranged to activate the tracking laser when a fast-moving object (such as, for example, a missile) is detected, thereby providing range information to determine the velocity (for example, speed and direction) of the object. The velocity determination can be used to filter out false positive missile attack alarms, such as, for example, static or slow-moving energy sources, like ground reflections or sunlight. This prevents false positive missile attack alarms.

The ITDS device 1 can provides detection and accurate angle of attack and range information without the use of radar, allowing the system to be used on stealthy platforms.

The FSM device 42 can be arranged to operate as fast-steering mirror that can track and lock on to fast moving objects in real-time. The laser source 11 can be arranged to steer a high-power laser and stay locked-on to the moving object in real-time until the object or its guidance system is destroyed, damaged or rendered inoperable.

Referring to FIGS. 1-4 and 6, the ITDS device 1 can be arranged to combine several T-LFR modules 5 with the infrared (IR) disruptor module 3 to create system capable of tracking and disrupting moving objects such as, for example, IR homing missiles.

FIG. 7 shows a non-limiting embodiment of the disruptor controller 100-3 that can be included in the disruptor module 3. The controller 100-3 can be arranged to interact with the master processor 106 via a communication link such as, for example, the RS422 bus. The disruptor controller 100-3 can be arranged to control and operate the disruptor module 3, including the FSM device 42 to direct and steer a disruptor laser on to a moving object.

In this non-limiting embodiment, the disruptor controller 100-3 can comprise at least one processor 105, an analog-to-digital convert (ADC) group 115 (including, for example, 115a, 115b, 115c, 115d), a transimpedance amplifier (TIA) group 120 (including, for example, 120a, 120b, 120c, 120d), an ADC 125, a TIA 130, a laser driver 135, a digital-to-analog (DAC) group 140 (including, for example, 140A, 140b), an ADC group 145 (including, for example, 145A, 145B), a differential I-drive group 150 (including, for example, 150A, 150B), and a differential amplifier group 155 (including, for example, 155A, 155B). The disruptor controller 100-3 can comprise, or it can be connected to, any of the laser source 11, the FSM device 42, and DPR 62, which in this embodiment comprise an MIR pulsed laser (11), a 15 mm VCM (42), and a quadrant MIR detector (62), respectively.

The processor 105 (or master processor 106) can include any one or more computing devices, communicating devices or computing resources. The processor 105 and master processor 106 can each include any combination of, for example, a central processing unit (CPU), an ARM (Advanced Risk Machines) CPU, a graphic processing unit (GPU), a general-purpose GPU (GPGPU), a field programmable gate array (FGPA), an application-specific integrated circuit (ASIC), a system-on-a-chip (SOC), a single-board computer (SBC), a complex programmable logic device (CPLD), a digital signal processor (DSP), a many core processor, multiple microprocessors, or any computing device architecture capable of performing the operations described or contemplated herein. The processor 105 can include a storage (not shown). In the embodiment depicted in FIG. 6, a storage 101 is provided that can interact with the master processor 106. The processor 105 can be arranged to interact with the storage 101 directly or via the master processor 106.

The storage 101 can include a read-only memory (ROM), a random access memory (RAM), or a hard disk drive (HDD). The storage 101 can provide nonvolatile storage of data, data structures, and computer-executable instructions, and can accommodate the storage of any data in a suitable digital format.

The storage 101 can include a computer-readable medium that can hold executable or interpretable computer code (or instructions) that, when executed by the processor 106 (or 105), cause the steps, processes and methods in this disclosure to be carried out. The computer readable medium can include sections of computer code that, when executed, cause the controller 100 to search, detect, lock-on and track moving objects, as well as to direct and hold an disruption laser on the object, such that the object is destroyed or damaged, or the speed or direction of the object is altered.

A basic input-output system (BIOS) can be stored in the storage 101, which can include, for example, a ROM, an erasable programmable read-only memory (EPROM), or an electrically erasable programmable read-only memory (EEPROM). The BIOS can contain the basic routines that help to transfer information between any one or more of the computing resources or computing devices in the controller 100, such as during start-up.

In the embodiment depicted in FIG. 6, the storage 101 includes an EEPROM.

The processor 105 can be arranged to interact, either directly or via the master processor 106, with any of the components in the controller 100, and, more generally, the ITDS device 1, to carry out or facilitate the processes included, described or contemplated by this disclosure.

In the non-limiting embodiment depicted in FIG. 7, the processor 105 comprises a CPU and a DSP. The DSP can be provided in the form of one or more computing resources. The DSP can be provided as a separate computing device, or it can be integrated into the processor 105. The DSP can include signal acquisition hardware or computing resources to sense the frequency and harmonic content of the outgoing laser pulses as the digital reference signal, and the reflected laser pulse signal from the DPR 62. Both the digital reference signal and the received reflected laser pulse signals can be fed into a DSP-based lock-in amplifier. The reference signal can be determined based on, for example, an output of an ESPR device 35 or DPR device 60. The DSP can generate and output amplitude and phase information of the received pulses from the distant target.

The DSP-based lock-in amplifier can be included in the processor 105, or elsewhere in the controller 100. The DSP-based lock-in amplifier can be included in the TIA 130, or the differential amplifiers 155, or elsewhere in the controller 100. The lock-in amplifier (for example, in the processor 105) can be arranged to sample an output from an ESPR device 35 (or DPR device 60) to determine the frequency, wavelength, phase, timing, or power level of the laser emitted from the laser source 10 (or 11).

In an alternative embodiment, the sampled (or digital) reference signal and returned reflected laser pulse signals can be processed by the processor 105 using DSP techniques to improve signal to noise ratio and reject false positive signals.

Regarding the digital reference signal, the outgoing laser pulses can be monitored and timed by the processor 105 via the TIA 130 and ADC 125. The TIA 130 can be coupled to the laser source 11 and configured to receive the frequency and harmonic content of the outgoing laser pulses and output an analog reference signal to the ADC 125. In this embodiment, the ADC 125 includes a sixteen (16) bit ADC that can convert the analog reference signal into a digital reference signal, which can then be output from the ADC 125 to an input of the processor 105.

Contemporaneously, reflected laser pulses can be detected by the DPR 62, which in this non-limiting embodiment comprises a quadrant MIR (Q-MIR) sensor. The reflected laser pulses can include reflections of the outgoing laser pulses from the laser source 11 (or laser source 10), as they are reflected from the target and collected by the DPR 62 in the disruptor module 3 (for example, shown in FIGS. 1-3). When impinged by a reflected (or return) laser pulse, the DPR 62 can generate and output a pulse detection signal corresponding to the strength and location of the impinging return laser pulse. The pulse detection signal can be amplified by the TIA group 120 and sampled to digital form by the ADC group 115, which in this embodiment comprises four sixteen (16) bit ADCs. The digital pulse signal can be output from the ADC group 115 to an input of the processor 105, as seen in FIG. 7. Each of the TIAs in the TIA group 120 can include a variable gain amplifier that can be adjusted based on a reference voltage to filter out noise from the detected signal, including noise that is 30 dB or more. The variable gain amplifier can be arranged to provide a wider dynamic range, for example, so more distant targets have high gain but closer targets have lower gain. This can stop the reflections from saturating the ADC. The gain can be time dependent, so starting with low gain when the laser pulse is sent, then ramping up gain with time, so that the gain is proportional to the attenuation laser pulse at different ranges.

The processor 105 can be arranged to control and drive the laser source 11, which in this embodiment includes the MIR pulsed laser configured to disrupt the moving object. The laser source 11 can be controlled or driven by means of the pulsed laser driver 135, which can be connected to the processor 105.

On the basis of the received digital reference signal and the received return laser pulse, the processor 105 (or the master processor 106 through interaction with the processor 105) can generate amplitude and phase information of the received pulses from the distant target. The amplitude information can be used to determine, for example, if the laser is reflecting off a target or going into free space. In the meantime, the phase can be used to determine, for example, the range to the target. This information can then be used by the processor 105 to drive the FSM device 42, via differential I-drives 150A, 150B, to nutate the laser pulse from the laser source 11, and thereby maintain a close lock between the angle of the FSM device 42 and the angle of the target. The mirror angle information and range information can be continuously fed back by the processor 105, via the master processor 106, to the host system controller 200 (shown in FIG. 6) at a high refresh rate.

The differential I-drive 150A can be arranged to control the FSM device 42 along the X-axis; and, the differential I-drive 150B can be arranged to control the FSM device 42 along the Y-axis. Together, the differential I-drives 150A, 150B can control the angular position of the FSM device 42 in two dimensions.

The host system controller 200 can include, for example, an onboard computer of an aircraft, a launcher, a camera, a display, or any device or system that might be able to use or benefit from use of the controller 100.

Information regarding the angle, direction and rate at which the FSM device 42 operates can be controlled by the processor 105 via the differential I-drive group 150 (150A, 150B) and differential amplifier group 155 (155A, 155B). Each differential I-drive 150A, 150B, can have an input connected to a respective DAC 140A, 140B, and an output connected to the FSM device 42. Each differential amplifier 155A, 155B can have an input connected to a respective ADC 145A, 145B, and an output connected to the FSM device 42. The differential I-drives 150A, 150B can be arranged to receive signals from the processor 105 via the DAC group 140 and drive the FSM device 42 to steer the outgoing laser from the laser source 11 biaxially.

The differential amplifiers 155A, 155B can be arranged to receive feedback signals from the FSM device 42 and send the signals in digital form, after sampling by the ADC converter 145, to the processor 105. The feedback signals can be processed to determine the position of the FSM device 42, including multidimensional angle information (X, Y, or Z angle). The feedback signals can be processed to determine a reference voltage that can be used by the DSP for noise filtering.

The real-time angle, direction of motion and rate of motion of the FSM device 42 can be known and controlled continuously by the processor 105.

Once a target is acquired, and the processor 105 in the controller 100-3 is operating in a tracking mode, the FSM device 42 can be operated to steer and maintain the disruptor laser locked on the moving object. The FSM device 42 can be arranged to nutate under control of the processor 105, including to nutate around the target and remain pointed consistently at the target, for example, based on the amplitude and range data received from the lock-in amplifier (for example, in the DSP in the processor 105). The very fast response time of the FSM device 42 can allow the controller 100-3 to remain locked on the target even under high radial velocity/acceleration conditions. The range data and the multidimensional angle data determined from the position of the FSM device 42 can be continuously output to the host system controller 200.

FIG. 8 shows a non-limiting embodiment of a T-LRF controller 100-5, constructed according to the principles of the disclosure. Each T-LRF module 5 can include the controller 100-5, or one of the embodiments of T-LRF controllers described in the commonly-owned co-pending U.S. patent application Ser. No. 17/225,281, filed Apr. 8, 2021, titled “TRACKING LASER RANGEFINDER SYSTEM AND METHOD.” As seen in the embodiments depicted in FIGS. 7 and 8, the T-LRF controller 100-5 can share a similar architecture with that of the disruptor controller 100-3, with many components in common.

In addition to the components that are common between the controller 100-3 (FIG. 7) and controller 100-5 (FIG. 8), this embodiment of the T-LRF controller 100-5 can include a group of four high-voltage (HV) amplifiers 150 (150A, 150B, 150C, 150D), a high-voltage power supply unit (HV PSU) 153 that powers each of the HV amplifiers 150, and a DAC group 140 (140A, 140B, 140C, 140D) that provides a control voltage signal to each respective HV amplifier, including an X+, X−, Y+or Y− control voltage signal. By adjusting the control voltage signals, the processor 105 is able to control the position, direction and rate of movement of the FSM device 40.

This embodiment also includes the DPR 62 connected to a TIA 127 and ADC 117. The DPR 62 can be arranged to output a pulse detection signal to the TIA 127 upon detecting a return laser pulse. After amplification of the signal by the TIA, the pulse detection signal can be sampled by the ADC 125 and sent to an input of the processor 105 in digital form, where the digital detection signal can be processed by the processor 105 and used in controlling the FSM device 40. The digital detection signal can be used by the processor 105 to control the laser source 10 or reference value for noise filtering by lock-in amplifiers.

In an embodiment, the controller 100-5 can be arranged to operate in a passive mode. The lock-in amplifier can be included to extend the range and performance of each T-LRF module 5, while simultaneously maintaining an eye-safe aspect of the laser. The lock-in amplifier can be arranged to allow the received reflected pulse signal to be 30 dB or more below a noise floor of the ambient optical and electronic noise present at the receiver, and still have the received reflected pulse signal discernable. The lock-in amplifier can be arranged to generate amplitude information, which can then be used for target presence detection and phase determination, the latter being useable for range finding and calculation.

The controller 100-5 can be arranged to operate in any number of modes, including any of: a search mode for finding a target by sweeping the laser in a search pattern; a tracking mode where the laser is held on the target to generate continuous range and dual-axis (or three-axis) angle information (for example, angle X, angle Y, or angle Z and distance D data); and, an object disruption mode where the disruptor laser can be steered to and locked on to a moving target, such as, for example, the center of an IR seeking head, or boresighted to the body of the target, and maintained on the target as the target moves in real-time. The controller 100-5 can be arranged to provide range and multidimensional angle (X, Y, and/or Z) angle information, which can be continuously output to the host system controller 200 in real-time.

For the search mode, the processor 105 can be arranged to acquire a target in the field of view. Under controller of the processor 105, the laser can be steered by the FSM device 40 in a search pattern to locate potential targets. The processor 105 can receive a cue, such as, for example, from the host system controller 200, which can include approximate multidimensional (X, Y, or Z) co-ordinates and range data from long range sensors in order to reduce the acquisition time and prevent falsely locking onto the wrong target. During this phase, amplitude and range information can be fed back, by the processor 105, to the host system controller 200 to aid selection of the correct target.

In the case of the passive monitoring by the T-LRF controller 100-5, the signals from the DPR device 60 (for example, QAPD) and the DPR 62 (for example, Q-MIR sensor) can be digitally integrated by the processor 105 over a period of, for example, about one millisecond (1 ms) to improve signal to noise ratio. The integration time can be dictated by the fastest response time of the FSM device 40 (or 42).

As discussed above, the ITDS device 1 can include, at least the following:
an FSM device comprising a voice coil beam steering mirror to reduce size or footprint, whilst improving response time compared to existing technologies, such as, for example, existing DIRCM systems;
integrating one or more T-LRF modules 5 as both a passive and active missile attack warning system and tracking system;
using the pulsed disruptor laser to provide range information to missiles;
including multiple T-LRF modules 5 to provide all aspect coverage;
using a combination of the T-LRF module 5 and disruptor module 3 ranging functions to discriminate against false alarm visible/IR signatures;
increasing the number of T-LRF modules 5 to decrease target acquisition times;
adjusting or setting the laser source 10 in the T-LRF modules 5 for wavelengths that would disrupt IR seeker heads, thereby enabling simultaneously multi-missile disruption;
using the passive mode on the T-LRF modules 5 to eliminate emissions that missiles might lock on to;
setting or adjusting the wavelength of the laser pulse so that it is unlikely to be detected as it is outside the active wavelength bands of legacy and modern IR missiles;
providing detection and accurate angle of attack and range information without the use of radar, allowing the ITDS device 1 to be used on stealthy platforms;
smaller, lighter, lower power and cost than existing technologies, in-part due to the inclusion of compact FSM devices, such as, for example, MEM or VCM mirrors; and
others.

The terms “a,” “an,” and “the,” as used in this disclosure, means “one or more,” unless expressly specified otherwise.

The term “backbone,” as used in this disclosure, means a transmission medium that interconnects one or more computing devices or communicating devices to provide a path that conveys data signals and instruction signals between the one or more computing devices or communicating devices. The backbone can include a bus or a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The terms “communicating device” and “communication device,” as used in this disclosure, mean any hardware, firmware, or software that can transmit or receive data packets, instruction signals, data signals or radio frequency signals over a communication link. The device can include a computer or a server. The device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a communicating device, a computer resource, a processor, a microprocessor (μC), a central processing unit (CPU), a graphic processing unit (GPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The terms “computing resource” or “computer resource,” as used in this disclosure, means software, a software application, a web application, a web page, a computer application, a computer program, computer code, machine executable instructions, firmware, or a process that can be arranged to execute on a computing device as one or more processes.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The terms “including,” “comprising” and their variations, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The terms “send,” “sent,” “transmission,” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. An integrated tracking laser defense system for detecting and disrupting moving objects, the system comprising:
a disruptor module arranged to steer and direct a laser on to a moving object; and
a plurality of tracking laser rangefinder modules, each arranged to detect and track an object as it moves in a field-of-view,
wherein the plurality of tracking laser rangefinder modules are arranged around the disruptor module, and
wherein the disruptor module comprises a fast-steering mirror device arranged to lock on to and maintain a position on the moving object as it moves in the field-of-view.

2. The integrated tracking laser defense system in claim 1, wherein the disruptor module comprises a pulsed laser source arranged to emit an infrared laser pulse that is deflected and steered by the fast-steering mirror device.

3. The integrated tracking laser defense system in claim 1, wherein the disruptor module comprises a detector photoreceptor arranged to receive a reflection of the laser and output a laser detection signal.

4. The integrated tracking laser defense system in claim 3, further comprising a processor arranged to receive the laser detection signal and determine at least one of an angle and a range of the moving object based on the laser detection signal and a position of the fast-steering mirror device.

5. The integrated tracking laser defense system in claim 4, wherein the processor is arranged to output the angle and range continuously and in real-time to a host system controller.

6. The integrated tracking laser defense system in claim 1, wherein at least one of the plurality of tracking laser rangefinder modules includes a laser source and a fast-steering mirror device.

7. The integrated tracking laser defense system in claim 6, wherein the laser source is arranged to emit a laser pulse having a wavelength of about 850 nm, about 905 nm or about 946 nm.

8. The integrated tracking laser defense system in claim 6, wherein the at least one of the plurality of tracking laser rangefinder modules includes a detector photoreceptor arranged to receive a reflection of a laser pulse emitted by the laser source and output a laser pulse detection signal.

9. The integrated tracking laser defense system in claim 8, wherein the at least one of the plurality of tracking laser rangefinder modules includes a module processor arranged to receive the laser pulse detection signal and, based on a position of the fast-steering mirror device at a time when the reflection of the laser pulse is detected, find and track the fast moving object in real-time.

10. The integrated tracking laser defense system in claim 8, wherein the processor includes digital signal processing arranged to filter optical or electronic noise to reject a false positive signal or to improve sensitivity of the at least one of the plurality of tracking laser rangefinder modules.

11. The integrated tracking laser defense system in claim 8, wherein the processor includes digital signal processing arranged to filter optical or electronic noise to improve sensitivity of the at least one of the plurality of tracking laser rangefinder modules.

12. A computer-implemented method for, when executed by one or more processors, detecting and disrupting a moving object by an integrated tracking laser defense system having a disruptor module and a plurality of tracking laser rangefinder modules, the method comprising:
detecting, by a detector photoreceptor, a laser pulse reflected by an object impinged by the laser;
outputting, by the detector photoreceptor, a laser pulse detection signal based on the detected laser pulse;
determining continuously and real-time, by a processor, a position of the object based on the laser pulse detection signal; and
controlling, by a fast-steering mirror device, a disruptor laser to track the object as it moves in a field of view,
wherein the position of the object is determined continuously and in real-time based on the position of the fast-steering mirror device while tracking the object as it moves in the field of view.

13. The computer-implemented method in claim 12, the method further comprising:
continuously determining, by the processor, angle and range information to the object.

14. The computer-implemented method in claim 13, the method further comprising:
sending the angle and range information in real-time to a host system controller.

15. The computer-implemented method in claim 12, wherein the detector photoreceptor is located in the disruptor module or in at least one of the plurality of tracking laser range finder modules.

16. The computer-implemented method in claim 12, wherein the fast-steering mirror device is located in the disruptor module or in at least one of the plurality of tracking laser range finder modules.

17. The computer-implemented method in claim 12, the method further comprising:
emitting, by a laser source, an outgoing laser pulse;
sampling the outgoing laser pulse;
determining, by the processor, a reference lock-in voltage based on the sampled outgoing laser pulse; and
applying, by the processor, the reference lock-in voltage to an amplifier to generate amplitude and phase information.

18. The computer-implemented method in claim 12, further comprising:
sending information about the position of the object to a host system controller,
wherein the position of the object comprises angle and range information, and,
wherein the angle and range information is sent continuously and in real-time to the host system controller.

19. A non-transient computer-readable medium containing computer instructions or computer code that, when executed by one or more processors, cause an integrated tracking laser defense system to perform computer-implemented operations for detecting or disrupting a moving object, including operations comprising:
detecting, by a detector photoreceptor, a laser pulse reflected by an object impinged by the laser;
outputting, by the detector photoreceptor, a laser pulse detection signal based on the detected laser pulse;
determining continuously and real-time, by a processor, a position of the object based on the laser pulse detection signal; and
controlling, by a fast-steering mirror device, a disruptor laser to track the object as it moves in a field of view,
wherein the position of the object is determined continuously and in real-time based on the position of the fast-steering mirror device while tracking the object as it moves in the field of view.

20. The non-transient computer-readable medium in claim 19, the operations further comprising sending angle and range information for the object as it moves in the field of view, continuously and in real-time, to a host system controller.
